(19) United States
(12) Patent Application Publication
(10) Pub. No.: US 2024/0016180 A1
(43) Pub. Date: Jan. 18, 2024

(54) Method for producing functional pulse protein

(71) Applicant: Regents of the University of Minnesota, Minneapolis, MN (US)

(72) Inventors: Baraem Pamela Ismail, Shorewiew, MN (US); Alissa Ann Schneider, St. Paul, MN (US)

(21) Appl. No.: 18/034,273

(22) PCT Filed: Nov. 1, 2021
(86) PCT No.: PCT/US2021/057566

§ 371 Date: Apr. 27, 2023

Related U.S. Application Data
(60) Provisional application No. 63/107,797, filed on Oct. 30, 2020.

(51) Int. Cl. A23J 3/14; A23J 1/14; A23L 29/30

(52) U.S. Cl. CPC A23J 3/14; A23J 1/14; A23L 29/35

(57) ABSTRACT

A method of producing a functional pulse protein exhibiting increased water solubility and thermal stability compared to native pulse protein in acidic conditions and containing no stabilizing ingredients. The method includes initially providing a pulse protein flour comprising pulse protein and pulse starch. The pulse protein is separated from the pulse starch to produce a pulse protein isolate and a pulse starch rich component containing primarily pulse starch and insoluble fiber. The pulse starch rich component is partially hydrolyzed to produce primarily maltodextrin resulting in a treated pulse starch component. The treated pulse starch component and the pulse protein isolate are then combined and incubated to induce the initial stage of the Maillard reaction until an Amadori product is produced resulting in partially glycated protein. The partially glycated protein is then purified to produce a partially glycated pulse protein ingredient.

### BACKGROUND

This disclosure relates to a method for producing a pulse protein having improved functionality with greater solubility and thermal stability compared to its native counterpart in acidic food and beverage applications and a product of such method and in particular it relates to a method producing such pulse protein by protein glycation with hydrolysis of the pulse starch component to produce a pulse starch hydrolysis product.

By 2025, the global demand for protein ingredients is expected to reach 7 million tons and generate revenues of nearly $70 billion. Specifically, there is a growing interest in novel plant-based protein ingredients to partially replace a market sector that has been dominated by traditional protein ingredients such as milk and soy proteins. Reasons that have led to this interest include increasing number of vegan, flexitarian and health conscious consumers, and a growing interest in sustainable and environment friendly sources.

Consumers and food manufacturers are looking for sources of protein that have a low environmental impact and meet dietary restrictions. Therefore, interest in pulse protein (pea, bean, chickpea, lentil, mung bean, and fava beans) and especially pea protein has exploded in recent years. With global manufacturers investing in pulse protein ingredients, it is vital that these products function well in food applications. As it stands, pulse proteins lack some of the functional attributes, such as solubility and thermal stability, of other proteins, such as whey and soy proteins. Protein beverages presently on the market are mostly formulated using whey protein.

Plant-based protein beverages currently on the market have lower protein inclusion levels and shorter shelf-life. Presently low solubility and thermal stability of available plant-based protein ingredients is addressed by formulating such protein products with hydrocolloids that stabilize the protein, keeping it dispersed in a product such as a beverage. Protein hydrolysis has also been used to enhance overall functionality of protein ingredients that are currently utilized in foods. However, this method is limited, as it creates bitter peptides that reduce consumer acceptance.

There is a need for an enhanced plant protein for beverage application that will address consumer demand for plant-based products and high protein intake.

### SUMMARY

This disclosure describes a method of producing a functional pulse protein exhibiting increased water solubility and thermal stability compared to its native counterpart in acidic food and beverage applications. The method includes initially providing a pulse protein flour comprising pulse protein and pulse starch components. The pulse protein is separated from the starch to produce a pulse protein isolate and a starch rich component containing primarily pulse starch and insoluble fiber.

The pulse starch in the starch rich component is partially hydrolyzed to produce primarily maltodextrin resulting in a treated pulse starch component. The treated pulse starch component and the pulse protein isolate are then combined and incubated to induce the initial stage of the Maillard reaction until an Amadori product is produced resulting in partially glycated protein. The partially glycated protein is then purified to produce a purified partially glycated pulse protein.

This disclosure further describes the pulse protein being derived from peas, beans, lentils, fava beans, mung bean or chickpeas.

This disclosure further describes a method wherein the pulse starch rich component is partially hydrolyzed minimizing production of monosaccharides and disaccharides.

This disclosure further describes a method where in the partially glycated pulse protein product is purified.

This disclosure further describes a method wherein the partial hydrolysis of the pulse starch rich component results in the production of maltodextrins with dextrose equivalent of around 10-20.

This disclosure further describes a method wherein no exogenous sugars are used to produce the partially glycated pulse protein ingredient.

This disclosure further describes a method wherein the pulse protein ingredient is 50 to 90% protein.

This disclosure further describes a method wherein the pulse protein ingredient contains no stabilizing ingredients.

This disclosure also describes a composition derived from pulse flour, the composition comprising a partially glycated pulse protein wherein approximately 15 to 40% of available amine sites are bonded to maltodextrin.

This disclosure further describes a composition wherein the composition contains no stabilizing ingredients.

This disclosure further describes a composition wherein the pulse protein is derived from peas, beans, lentils, fava beans, mung beans or chickpeas.

This disclosure further describes the composition as being thermally stable in acidic conditions.

This disclosure also describes a reaction product resulting from incubation of maltodextrin and pulse proteins wherein the reaction is characterized by a pH of approximately 7, relative humidity of 40-49%, at a temperature below the denaturation point of the protein such as 60° C., and incubation duration of approximately 24-96 hours.

This disclosure further describes the reaction product as containing no stabilizing ingredients.

This disclosure further describes the reaction product with the pulse protein being derived from peas, beans, lentils, fava beans, mung beans or chickpeas.

This disclosure further describes the reaction product as being thermally stable in acidic conditions.

### BRIEF DESCRIPTION OF DRAWINGS

FIG. 1 are two photographical views of (a) pea protein isolate (PPI) and (b) starch-rich fraction powders.

FIG. 2 is a photographical view of the combined maltodextrin sample of 7 replicates.

FIG. 3 is a graphical view of chain length profile of maltodextrin obtained by HPAEC-PAD.

FIG. 4 includes photographic views of 8 replicates of non-glycated pea protein isolate and maltodextrin before incubation and partially glycated pea protein (PG-PP) after 24 hours of incubation at 49% relative humidity and 60° C.

FIG. 5 is a compilation of three photographical views of SDS-PAGE gel visualizations of the protein profiles of PPI, non-glycated PPI and maltodextrin before incubation, and PG-PP after 24-hour incubation.

### DETAILED DESCRIPTION

In this description, a method is disclosed of producing a pulse protein product that is soluble and thermally stable for use as an ingredient in acidic foods and beverages. For purposes of this application pulses are dried edible seeds of plants from the legume family and may include peas, beans, chickpeas, lentils, fava beans, and mung beans.

In brief, starch and protein in the pulse flour are separated and the pulse starch is partially hydrolyzed to produce a primarily maltodextrin component. The maltodextrin component and the pulse protein are combined and the pulse protein is partially glycated under certain conditions and the glycated protein is purified to produce a useful food ingredient. The target is not greater than 15-40% amine blockage. Therefore, not all potential sites on the protein will be glycated, to preserve the nutritional quality of the protein.

The method of this disclosure eliminates the need for stabilizing ingredients which are used on presently available plant-based protein products. Stabilizing ingredients on ingredient labels are not desirable. The method described herein provides the ability to market a product with a “clean label”, thus improving consumer acceptance.

Further, protein functionality is improved since enzymatic hydrolysis is limited and thus the release of bitter peptides and the formation of aggregates is minimized. The method of this disclosure does not involve the hydrolysis of proteins; therefore, the pulse protein product of this disclosure will not have these issues.

The method described herein starts with pulse flour. Pulse flour is a product of drying pulse seeds, grinding the seed to a particulate size that is typical of flour making. The grinding can be done by any commercially known method such as milling. The pulse flour mainly includes pulse proteins, starch, and fiber. Pulse protein ingredients produced conventionally from this flour lag behind soy and whey protein ingredients in several functional attributes needed for different food applications. By functional attributes is meant that pulse protein is not as soluble nor as thermally stable as other types of proteins, such as whey or soy protein, commonly used in high protein foods. By high protein is meant at least 10 g of available protein in an 8 fl. oz. serving (or approximately 4.2% available protein in a beverage (w/v)). Currently, pulse protein-based beverages such as pea protein-based beverages are not stable at this level and have a short shelf life. Generally thermal stability is measured at a pH of approximately 3.4 for acidic beverages. For purposes of this application, by “thermal stability” is meant that the partially glycated pulse protein maintains or improves its solubility after thermal processing for example by pasteurization.

To produce a pulse protein that has thermal stability and can be readily soluble in acidic conditions, it is believed that Maillard-induced, partial glycation of pulse proteins enhances the solubility and thermal stability of the pulse protein especially for acidic beverage applications. The enhanced functionality allows for greater inclusion levels of the ingredient in such beverage applications and a longer product shelf life, especially in acidic beverages.

Another advantage of the method of this disclosure is the elimination of an external reducing sugar. Instead, the process of this disclosure utilizes an endogenous reducing sugar from the pulse flour. After the pulse protein and the pulse starch are separated, the reducing sugar source is produced by partially hydrolyzing native starches found in the pulse flour.

The partial hydrolysis produces maltodextrins with the desired reducing power. Partial hydrolysis is intended to produce maltodextrins with an average degree of polymerization less than 20 and a DE of about 10-20.

After partial hydrolysis, the maltodextrin and the pulse protein are combined and the combination is stored under conditions suitable to initiate a Maillard reaction, which effectively produces partially glycated pulse proteins. By partially glycated pulse protein it is meant that the maltodextrin and the pulse protein are bonded covalently at reactive sites, such as amine groups of lysine, up to 15 to 40% of available amine sites. The storage under conditions suitable to initiate a Maillard reaction will be sometimes referred to herein as “incubation”. The extent of the Maillard reaction is limited to an initial stage resulting in the production of Amadori products (glycated pulse protein). Limiting the extent of the Maillard reaction prevents browning, off flavor formation and loss of protein structure and functionality that is associated with the advanced and final stages of the Maillard reaction. The extent of the Maillard reaction is limited by controlling the pH, relative humidity, temperature, and the time of the reaction. Such parameters are for example pH of approximately 7, relative humidity of 40-49%, at a temperature below the denaturation point of the protein such as 60° C., and incubation duration of approximately 24-96 hours.

After incubation, the glycated pulse protein is purified to produce an ingredient with 50-90% partially glycated pulse protein.

### Example

The following example demonstrates the effects of the partial glycation of pea protein with the hydrolysis of pea starch to produce a suitable pea protein ingredient for use in a food product and beverage and is not to be taken as limiting the present application to pea protein.

A. Pea Protein Isolate (PPI) Extraction from Pea Flour

### Materials

1. Yellow pea flour (approximately 20-30% protein, dry basis (D.B.) and 50-60% starch D.B.)
2. 2M NaOH
3. 2M HCl
4. Double-distilled deionized water (DDW)

### Specific Supplies and Equipment

1. LECO® FP828 nitrogen analyzer (LECO, St. Joseph, MI, USA)
2. SnakeSkin™ dialysis tubing with 3.5 kDa molecular weight cut-off (Thermo Fisher Scientific Inc., Waltham, MA, USA)

### Procedure

1. Approximately 200 g of pea flour was placed into a 2000 mL glass beaker and suspended in 2000 mL of DDW by stirring at medium speed on a magnetic stir plate.
2. Once the flour was well dispersed and suspended, the pH was adjusted to approximately 7.5 with 2M NaOH and stirred at medium speed for approximately 1 hour.
3. The pH of the pea flour dispersion was again adjusted to approximately 7.5 with 2M NaOH after 1 hour of stirring, then centrifuged at approximately 5000×g for approximately 30 minutes in 500 mL centrifuge bottles.
4. The supernatant from each bottle was retrieved and collectively transferred to a 2000 mL beaker.
5. Approximately 2000 mL DDW was added back to the formed pellets, evenly splitting between the bottles. The pellet in each bottle was re-dispersed in DDW by stirring at medium speed.
6. The pH of the dispersion in each bottle was adjusted to approximately 7.5 with 2M NaOH and stirred at medium speed for approximately 1 hour.
7. The pH of the dispersions in each bottle was again adjust to approximately 7.5 after 1 hour of stirring, then centrifuged at approximately 5000×g for approximately 30 minutes.
8. The supernatant from each bottle was retrieved and collectively transferred to a 2000 mL beaker.
9. The insoluble pellets remaining from centrifuging the pH 7.5 pea flour dispersions were combined, lyophilized, and ground to a fine powder using a mortar and pestle. The resulting powder is referred to as the starch-rich fraction, used to produce maltodextrin in Section B.
10. The pH of the supernatants collected in the two 2000 mL beakers was adjusted to approximately 4.5 with 2M HCl, turning an opaque, white color at approximately pH 4.5.
11. The pH 4.5 dispersions in two 2000 mL beakers were transferred to 500 mL centrifuge bottles.
12. The bottles with pH 4.5 dispersions were centrifuged at approximately 5000×g for approximately 10 minutes.
13. The supernatant from each bottle was discarded.
14. The mass (grams) of the resulting pellet (the protein precipitate) in each centrifuge bottle was determined.
15. The resulting protein precipitate pellets were combined and dispersed in four times the mass (grams) in mL of DDW, in a 1000 mL beaker by stirring at medium speed on a magnetic stir plate (e.g. 100 grams of pellet dispersed in 400 mL of DDW).
16. As the protein precipitate was dispersing, the pH was adjusted to approximately 7.0 with 2M NaOH (turning a lightly translucent, amber color). The solution was stirred until the precipitate was completely dissolved in the DDW (approximately 2 hours), periodically checking and adjusting the pH to approximately 7.0 over time.
17. Once the protein precipitate was fully dissolved (no white precipitate visible), the solution was dialyzed with DDW using SnakeSkin™ dialysis tubing with 3.5 kDa molecular weight cut off (MWCO) from Thermo Fisher Scientific Inc. (Waltham, MA, USA).
18. The dialyzed protein solution was lyophilized and ground to a fine powder (PPI) using a mortar and pestle.
19. The protein content of the resulting powders (PPI and starch-rich fraction) was determined by the Dumas method (AOAC 990.03) using a protein conversion factor of 6.25.

### Analysis and Results

Photos of the produced PPI and starch-rich fraction were taken for reference and the protein content was determined using a LECO® FP828 nitrogen analyzer (LECO, St. Joseph, MI, USA) by the Dumas method (AOAC 990.03) using a protein conversion factor of 6.25. FIG. 1 includes a photo of (a) PPI and (b) starch-rich fraction powders produced.

TABLE 1
Protein extraction purities of the PPI and starch-rich pellet.

| Sample | Protein Purity (%) |
|---|---|
| PPI | 88.9 |
| Starch-rich fraction | 2.83 |

B. Maltodextrin Production from Starch-Rich Fraction of PPI Extraction

Following this procedure, approximately 3.5 g maltodextrin was produced from the starch-rich fraction powder. This procedure was replicated 7 times and the maltodextrin produced from each replicate was combined to produce approximately 24.5 g total maltodextrin.

### Materials

1. Lyophilized starch-rich fraction from PPI extraction (Section A.9)
2. Calcium chloride (CAS 10043-52-4)
3. Novozymes BAN® 480 LS alpha-amylase (Novozymes North America, Inc., Franklinton, NC, USA)
4. 1M HCl and 1M NaOH
5. Double-distilled deionized water (DDW)

### Specific Supplies and Equipment

1. 250 mL jacketed beaker
2. Circulating water bath
3. Brabender® Micro Visco-Amylo-Graph (MVAG) (C.W. Brabender® Instruments, Inc., Hackensack, NJ)
4. SnakeSkin™ dialysis tubing with 3.5 kDa molecular weight cut-off (Thermo Fisher Scientific Inc., Waltham, MA, USA)

### Procedure

1. Initially, a jacketed beaker was preheated to approximately 80° C. using a circulating water bath. The MVAG instrument system water bath was preheated to approximately 25° C. Both were preheated for approximately 1 hour.
2. Approximately 100 mL 10% pea starch solution was made by combining approximately 8.8 g of the starch-rich fraction powder with approximately 101.2 g of 2 mM CaCl₂ DDW (specific weights accounted for correction of pea flour to approximately 14% moisture) in a 140 mL beaker.
3. The starch solution was heated in the MVAG instrument to gelatinize the starch granules into a slurry by increasing the temperature at a rate of approximately 10° C./min to approximately 95° C. and holding the temperature for approximately 5 minutes at approximately 95° C.
4. The starch slurry was transferred to the preheated 250 mL jacketed beaker and stirred at medium speed on a magnetic stir plate. The starch slurry was allowed to cool to approximately 75° C. (80° C. circulating water will hold the slurry at 75° C.).
5. Approximately 80 uL alpha-amylase (Novozymes BAN® 480 LS) was added to the slurry, followed by stirring and incubating at approximately 75° C. for approximately 5 minutes.
6. After approximately 5 minutes the pH was immediately adjusted to approximately 3.0 and incubated at approximately 75° C. and at a pH of approximately 3.0 for approximately 5 minutes to inactivate the enzyme.
7. The resulting dispersion was transferred to a beaker and allowed to cool to room temperature on ice while being stirred and the pH adjusted to approximately 7.0.
8. The dispersion was then centrifuged at approximately 5000×g for approximately 10 minutes.
9. The supernatant was transferred to 3.5 kDa Snakeskin™ dialysis tubing and dialyzed with DDW.
10. The dialyzed supernatant was lyophilized and ground to a fine powder using a mortar and pestle. The resulting powder is considered maltodextrin.

### Analysis and Results

A photo of the produced maltodextrin (7 replicates combined) were taken for reference.

Next, the dextrose equivalent (DE or % reducing sugars) of the maltodextrin was determined using a glucose standard curve (0.1-0.6 mM) as outlined by Shao & Lin (2018).

DE indicates the reducing power of the maltodextrin and classification as maltodextrin (typically, maltodextrin DE<20).

Lastly, the chain length profile of the maltodextrin was evaluated to verify hydrolysis and production of maltodextrin (hydrolyzed starch with average degree of polymerization (DP)>5 are maltodextrins and mostly DP 2-20) (Huber & BeMiller, 2017). Analysis was completed based on the method of Annor, Bertoft, & Seetharaman (2014) with some adjustments. Maltodextrin (approximately 2.0 mg) was dissolved in 90% DMSO (approximately 100 μL) with gentle stirring overnight, followed by filtration with a 0.45 μm nylon filter. The sample was analyzed by high-performance anion-exchange chromatography (HPAEC) with a Dionex™ ICS 5000+ system containing a CarboPac™ PA100 ion-exchange column (4×250 mm) and accompanying guard column (4×50 mm), coupled with a pulsed amperometric detector (PAD) (Thermo Fisher Scientific Inc., Waltham, MA, USA). An eluent gradient was utilized using a combination of 150 mM sodium hydroxide (Eluent A) and 150 mM sodium hydroxide containing 500 mM sodium acetate (Eluent B) as described elsewhere (Annor et al., 2014). Areas under peaks were corrected to carbohydrate concentration according to Koch et al. (1998).

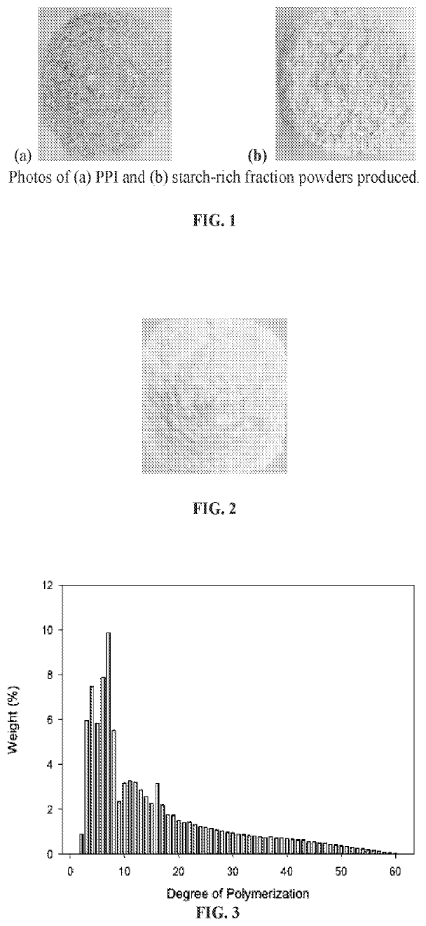

FIG. 2 includes a photo of the combined maltodextrin sample of 7 replicates.

The average DE of the maltodextrin was approximately 15.7. The chain length profile of maltodextrin obtained by HPAEC-PAD is shown in FIG. 3.

### C. Preparation of Partially Glycated Pea Protein (PG-PP)

Partially glycated pea protein (PG-PP) was produced by carrying out a dry-heating method. The produced pea protein isolate (PPI) and maltodextrin were combined and incubated under certain conditions in a constant climate chamber to initiate and limit the Maillard reaction.

### Materials

1. 0.01M potassium phosphate buffer (approximately pH 7.0)
2. Pea protein isolate (PPI) from extraction (Section A)
3. Produced pea maltodextrin (Section B)
4. 2M HCl and 2M NaOH
5. Double-distilled deionized water (DDW)

### Specific Supplies and Equipment

1. 100 mm×15 mm sterile, polystyrene petri dishes
2. Memmert® constant climate chamber HPP260 (Memmert®, Buchenbach, Germany)

### Procedure

1. 500 mL 0.01M potassium phosphate buffer (approximately pH 7.0) solution was prepared.
2. Protein and maltodextrin mixture in a 1:4 ratio was made as follows:
   Approximately 80 mL of buffer was added to approximately 20 g of maltodextrin in a 200 mL beaker and stirred until the maltodextrin was visibly dissolved. Approximately 5.624 g PPI (5 g protein needed, so PPI mass was adjusted to correct for 88.9% protein content of PPI) was slowly added to the buffer and maltodextrin solution and stirred until fully dispersed. The pH was adjusted to approximately 7.0.
3. The solution (PPI and maltodextrin in buffer) was lyophilized and was then ground into a fine powder using a mortar and pestle.
4. Approximately 2.472 g of the dried PPI and maltodextrin powder was placed in a standard 100 mm×15 mm petri dish and spread and smoothed into an approximately even layer using a lab spoon. Eight petri dishes with the powder were prepared.
5. The samples were then incubated in a Memmert® constant climate chamber (HPP260) (Memmert®, Buchenbach, Germany) by setting the chamber at approximately 60° C. and approximately 49% relative humidity. After the chamber reached the set conditions, the samples in petri dishes were placed in the chamber for approximately 24 hours. After incubation, the partially glycated pea protein (PG-PP) product was ground to a fine powder.

### Analysis and Results

Photos were taken and the color was measured using a calibrated Chroma Meter CR-221 (Minolta Camera Co., Osaka, Japan) of the mixed PPI and maltodextrin powder (non-glycated, before incubation) and after 24 hours of incubation (PG-PP).

Next, percent of free amino groups and percent loss of free amino groups after incubation was determined of the mixed PPI and maltodextrin powder (non-glycated, before incubation) and after 24 hours of incubation (PG-PP), based on the o-phthaldialdehyde (OPA) method outline by Goodno, Swaisgood, and Catignani (1981) using lysine as a standard (5-125 μg/mL).

Lastly, protein and glycoprotein profiling was completed by SDS-PAGE, as outlined by Boyle et al. (2018), and with Pierce™ glycoprotein staining (Thermo Fisher Scientific Inc., Waltham, MA, USA).

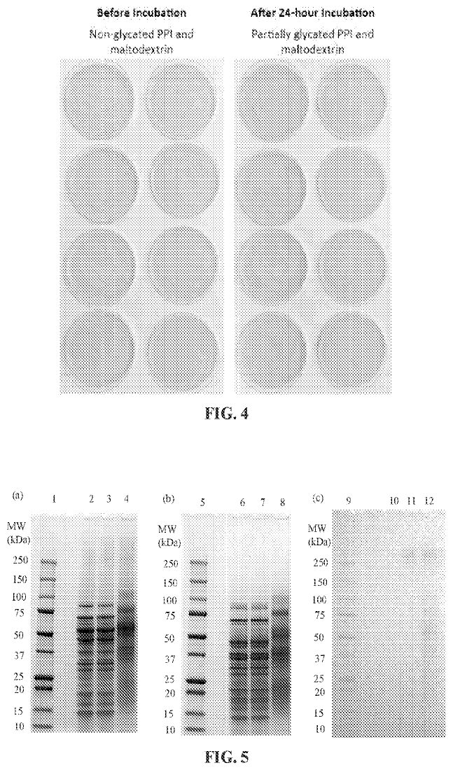

FIG. 4 includes photos of 8 replicates of non-glycated PPI and maltodextrin before incubation and PG-PP after 24 hours of incubation at 49% relative humidity and 60° C.

TABLE 2
L*a*b* color analysis of non-glycated PPI and maltodextrin
before incubation and PG-PP after 24 hours of incubation.

| | | Color | | |
|---|---|---|---|---|
| Sample | | L* | a* | b* |
| Before Incubation | Non-glycated | 84.62 | −1.91 | 15.14 |
| | PPI and maltodextrin | | | |
| After 24-hour Incubation | PG-PP | 82.69 | −1.84 | 15.78 |

TABLE 3
Percent of free amino groups of PPI, non-glycated PPI and maltodextrin,
and PG-PP and percent loss of free amines after incubation.

| | Free amino | Loss free amino |
|---|---|---|
| Samples | groups (%) | groups (%)* |
| PPI | 6.88 | N/A |
| Non-glycated PPI and maltodextrin | 6.77 | N/A |
| PG-PP | 4.84 | 29.6 |

*Non-glycated sample used as reference

FIG. 5 shows SDS-PAGE gel visualization of the protein profiles of PPI, non-glycated PPI and maltodextrin before incubation, and PG-PP after 24-hour incubation under (a) non-reducing conditions, (b) under reducing conditions, and (c) under non-reducing conditions with glycoprotein staining. Lane 1, 5, 9: Molecular weight (MW) marker; Lane 2, 6, 10: PPI; Lane 3, 7, 11: non-glycated PPI and maltodextrin; Lane 4, 8, 12: PG-PP.

### D. Hydrophobic Interaction Chromatography (HIC) Separation of Unreacted Maltodextrin

To separate the unreacted maltodextrin and further purify the protein, HIC was used. The following procedure details this procedure, for one injection. This procedure was repeated 30 times to gather a sufficient amount of purified protein for further structural and functional characterization.

### Materials

1. Ammonium sulfate (>99.5% purity) (CAS 7783-20-2)
2. Sodium hydroxide (CAS 1310-73-2)
3. Double-distilled deionized water (DDW)
4. 2M HCl, 2M NaOH, and 4M NaOH
5. Partially glycated pea protein (PG-PP) (Section C)

### Specific Supplies and Equipment

1. 0.45 μm nylon filters and glass filter apparatus
2. GE HiScale™ 50/20 column (GE Healthcare Bio-Sciences, Uppsala, Sweden)
3. Octyl Sepharose™ 4 Fast Flow HIC resin (GE Healthcare Bio-Sciences, Uppsala, Sweden)
4. 10 mL syringe and syringe injection adapter
5. Shimadzu Scientific Instruments high-performance liquid chromatography (HPLC) system with LC-6AD pump system, SPD-20AV UV/Vis detector, and a CBM-20A communication module (Shimadzu Corp., Kyoto, Japan)
6. SnakeSkin™ dialysis tubing with 3.5 kDa molecular weight cut-off (Thermo Fisher Scientific Inc., Waltham, MA, USA)

### Procedure

1. A Shimadzu Scientific Instruments high-performance liquid chromatography (HPLC) system with LC-6AD pump system, SPD-20AV UV/Vis detector, and a CBM-20A communication module (Shimadzu Corp., Kyoto, Japan) was used with a GE HiScale™ 50/20 column (GE Healthcare Bio-Sciences, Uppsala, Sweden) packed with Octyl Sepharose™ 4 Fast Flow HIC resin (GE Healthcare Bio-Sciences, Uppsala, Sweden) up to approximately 8 cm bed height (approximately 160 mL column volume (CV)).
2. Three separate mobile phases were prepared in 1 L volumes each; these were approximately 2M ammonium sulfate (approximately pH 7.0) in DDW, approximately 0.1M NaOH in DDW, and DDW. Each mobile phase was filtered through 0.45 μm nylon filters membranes using a vacuum pump and filter apparatus and degassed before use.
3. The PG-PP sample was prepared for injection by dispersing 0.5 g PG-PP powder in 10 mL 1M ammonium sulfate in a 30 mL beaker, by stirring at medium speed on a magnetic stir plate.
4. Once the PG-PP was sufficiently dispersed, the pH was adjusted to approximately 8.0 with 4M NaOH and stirred at medium speed for approximately 1 hour.
5. While the sample was stirring, approximately 3 CV of prepared DDW followed by approximately 2 CV prepared 2M ammonium sulfate mobile phases were run at flow rate of 15 mL/min.
6. The PG-PP dispersion pH was again adjusted to approximately 8.0 with 2M NaOH after 1 hour of stirring. Then, 8 mL of the dispersed sample was injected into the HPLC system using a 10 mL syringe and syringe injection adapter.
7. Following injection, the sample run began by eluting approximately 2.5 CV prepared 2M ammonium sulfate (15 mL/min), with detection at 220 nm and 280 nm.
8. Following, approximately 2.5 CV prepared DDW was eluted (15 mL/min). This fraction was collected once detector absorbance reading at 280 nm rose above 1 mAu. Collection stopped after the 280 nm absorbance readings fell below 1 mAu.
9. Following, approximately 3 CV prepared 0.1M NaOH was eluted (15 mL/min).
10. The pH of the collected fraction (containing DDW soluble protein) was adjusted to approximately 7.0 and dialyzed with DDW, using 3.5 kDa Snakeskin™ dialysis tubing.
11. The fraction was lyophilized and ground to a fine powder using a mortar and pestle. The resulting purified protein is referred to as purified partially glycated pea protein (purified PG-PP)

### Analysis and Results

The protein content of the purified PG-PP was determined using a LECO® FP828 nitrogen analyzer (LECO, St. Joseph, MI, USA) by the Dumas method (AOAC 990.03) using a protein conversion factor of 6.25.

The carbohydrate content, expressed as percentage glucose equivalent, was determined according to the method followed by Nielsen (2010), instead diluting the purified PG-PP powder as necessary.

Next, the solubility and thermal stability of the PG-PP and native pea protein isolate (Section A) was determined at pH 3.4, according to the method of Bu et al. (2022). Modifications included measuring the protein solubility at pH 3.4.

The average protein content of the purified PG-PP was approximately 71% protein.

The average glucose equivalent content of the purified PG-PP was approximately 22%

TABLE 4
Solubility of not heated and heated 5% protein solutions
of purified PG-PP and native PPI at pH 3.4.

Solubility (%)* ± SD**

| Sample | Not heated | Heated (80° C. for 30 minutes) |
|---|---|---|
| Purified PG-PP | 85.30 ± 0.07 | 93.66 ± 0.42 |
| Native PPI | 40.46 ± 0.32 | 57.56 ± 0.72 |

*Solubility expressed as percentage of soluble protein compared to the total protein content as determined by the Dumas method (Bu et al., 2022).
**Standard deviation

What is claimed is:

1. A method of producing a functional pulse protein exhibiting increased water solubility and thermal stability as compared to native pulse protein in acidic conditions, the method comprising:
providing a pulse protein flour comprising pulse protein and pulse starch;
separating the pulse protein from the pulse starch;
partially hydrolyzing the pulse starch to produce primarily maltodextrin;
combining the primarily maltodextrin with the pulse protein;
incubating the combined primarily maltodextrin and pulse protein to initiate a Maillard reaction until an Amadori product is produced resulting in a glycated pulse protein product;
purifying the glycated pulse protein product to produce a pulse protein ingredient.

2. The method of claim 1 wherein the pulse protein is derived from peas, beans, lentils, fava beans, mung beans or chickpeas.

3. The method of claim 1 wherein the pulse starch is partially hydrolyzed minimizing production of monosaccharides and disaccharides.

4. The method of claim 1 where in the glycated pulse protein product is purified.

5. The method of claim 1 wherein the partial hydrolysis of the pulse starch results in the production of maltodextrins with a dextrose equivalent of around 10-20.

6. The method of claim 1 wherein no exogenous sugars are used to produce the partially glycated pulse protein ingredient.

7. The method of claim 1 wherein the pulse protein ingredient is 50-90% protein.

8. The method of claim 1 where in the pulse protein ingredient contains no stabilizing ingredients.

9. A composition derived from pulse flour, the composition comprising:
a partially glycated pulse protein wherein approximately 15 to 40% of available amine sites are bonded to maltodextrin.

10. The composition of claim 9 wherein the pulse protein is derived from peas, beans, lentils, fava beans, mung beans or chickpeas.

11. The composition of claim 9 wherein the composition contains no stabilizing ingredients.

12. A reaction product from incubation of maltodextrin and pulse proteins wherein the reaction is characterized by a pH of approximately 7, relative humidity of 40-49%, at a temperature below the denaturation point of the protein such as 60° C., and incubation duration of approximately 24-96 hours.

13. The composition of claim 12 wherein the composition contains no stabilizing ingredients.

14. The composition of claim 12 wherein the pulse protein is derived from peas, beans, lentils, fava beans, mung beans or chickpeas.
